(19) United States
(12) Patent Application Publication
(10) Pub. No.: US 2001/0035194 A1
(43) Pub. Date: Nov. 1, 2001

(54) Tip for dental flossing device

(76) Inventor: Ravikumar S. Narayanan, Fort Collins, CO (US)

Correspondence Address: DORSEY & WHITNEY, LLP, SUITE 4700, 370 SEVENTEENTH STREET, DENVER, CO, 80202-5647, US

(21) Appl. No.: 09/883,013

(22) Filed: Jun. 15, 2001

Related U.S. Application Data
(63) Continuation of application No. 09/444,043, filed on Nov. 19, 1999.

(51) Int. Cl. A61C 15/00

(52) U.S. Cl. 132/321

(57) ABSTRACT

A flossing tip for a power dental flossing device. The tip is elongated and includes a base portion, a central portion having a generally rectangular cross-section, and an end portion. The base portion supports the tip when the tip is coupled to the dental flossing device. The central portion couples the base portion to the end portion. The end portion is inserted between a pair of adjacent teeth of a user, and helps guide and orient the tip between the adjacent teeth. When in use, the rectangular cross-section of the tip provides multiple points of contact against a tooth for cleaning, and also helps maintain the tip in proper orientation with respect to the teeth.

### FIELD OF THE INVENTION

This invention relates to a dental tip attachable to a power dental flossing device for cleaning between adjacent teeth and gum of a user.

### BACKGROUND OF THE INVENTION

Power dental flossing devices are motorized devices used to clean or floss the area between a user's teeth and gums. A power dental flossing device is provided with a removable tip for placement in the interdental or interproximal space between adjacent teeth and in the pockets between the teeth and gums. When the power dental flossing device is activated, the tip, if properly oriented, contacts and rubs against portions of the sides of adjacent teeth and helps to dislodge particles and remove plaque forming in those locations.

Conventional tips having a circular or square cross-section generally, and typically provide only one contact point along the side of a tooth being cleaned. One problem which can occur with a power dental flossing device is that ineffective cleaning may result if the tip is mis-oriented when inserted into the interproximal space between teeth. In particular, when the tip is mis-oriented, the area of the surface to be cleaned, contacted and accessed by the tip, is reduced thus reducing the efficiency of the cleaning. Further, a mis-oriented tip is more likely to break during use, or may become stuck between teeth.

What is needed is a tip for a power dental flossing device which provides improved cleaning and whose shape assists a user with properly orienting and inserting the tip between teeth.

### SUMMARY OF THE INVENTION

In light of the above, and according to a broad aspect of the invention, disclosed herein is a flossing tip for a power dental flossing device. The flossing tip is elongated and includes a base portion, a central portion, and an end portion. The base portion supports the tip when the tip is connected to the dental flossing device. The central portion has a substantially rectangular cross-section, and couples the base portion to the end portion. The end portion is inserted between a pair of adjacent teeth of a user, and helps guide the tip between the adjacent teeth. When in use, the substantially rectangular cross-section of the tip provides multiple points of contact against a tooth for cleaning, and also helps maintain the tip in proper orientation with respect to the teeth, thus providing more effective cleaning.

According to another broad aspect of the invention, the central portion has a top and a bottom surface, and a pair of sides, wherein the height of the sides is larger than the width of the top and bottom surfaces. The sides contact and engage the sides of the teeth, and in this manner, the tip is less likely to be rotated and mis-oriented once the tip is inserted between the teeth. In one example of the present invention, the sides of the central portion of the tip are curved, preferably inwardly.

The cross-sectional area of the tip along the central portion decreases along the length of the tip from the base portion to the end portion. The central portion has a top surface having a first width at the base portion, and a second smaller width proximate the end portion. Likewise, the height of the sides of the central portion decreases from the base portion to the end portion. In order to reduce the possibility of damage to the gums such as by poking, the edges of at least the central portion are rounded and the end portion of the tip is curved.

In another embodiment of the present invention, the tip has at least one strip of reinforcing material embedded with the central portion, for improved durability of the tip while maintaining the general flexibility of the tip.

According to another broad aspect of the invention, a method of flossing teeth with a dental flossing device is disclosed. The method includes the step of providing a tip with a substantially rectangular cross-section adapted to be inserted between a pair of teeth of a user, the tip adapted to be attached to the dental flossing device. The user then inserts the tip between the pair of teeth, and activates the power dental flossing device, thereby moving the tip at least vertically upwardly and downwardly along at least a portion of one side of the pair of teeth for cleaning.

The foregoing and other features, utilities and advantages of the invention will be apparent from the following more particular description of a preferred embodiment of the invention as illustrated in the accompanying drawings and claims.

### BRIEF DESCRIPTION OF THE DRAWINGS

FIG. 1 illustrates a perspective view of a power dental flossing device having a tip, in accordance with one embodiment of the present invention, attached thereto.

FIG. 2 illustrates a perspective view of a tip for a power dental flossing device, in accordance with one embodiment of the present invention.

FIG. 3 illustrates a top view of the tip of FIG. 2, in accordance with one embodiment of the present invention.

FIG. 4 illustrates a side view of the tip of FIG. 2, in accordance with one embodiment of the present invention.

FIG. 5 illustrates a bottom view of the tip of FIG. 2, in accordance with one embodiment of the present invention.

FIG. 6 illustrates a sectional view of the tip, in accordance with one embodiment of the present invention.

FIG. 7 illustrates a sectional view of the tip taken along section lines 7-7 of FIG. 6, in accordance with one embodiment of the present invention.

FIG. 8 illustrates a sectional view of the tip taken along section lines 8-8 of FIG. 6, in accordance with one embodiment of the present invention.

FIG. 9 illustrates a power dental flossing device with a tip in accordance with one embodiment of the present invention, inserted between a pair of adjacent teeth during use.

FIG. 10 illustrates a power dental flossing device with a tip in accordance with one embodiment of the present invention, inserted between a pair of adjacent teeth during use.

FIG. 11 is an exploded sectional view taken along section lines 11-11 of FIG. 9, and illustrates a tip in accordance with one embodiment of the present invention, inserted between a pair of adjacent teeth as the tip moves vertically upwardly and downwardly during use.

FIG. 12 illustrates a side view of an alternative embodiment of the tip of FIG. 2 of the present invention, where the tip has a surface treatment thereon.

### DETAILED DESCRIPTION OF A PREFERRED EMBODIMENT

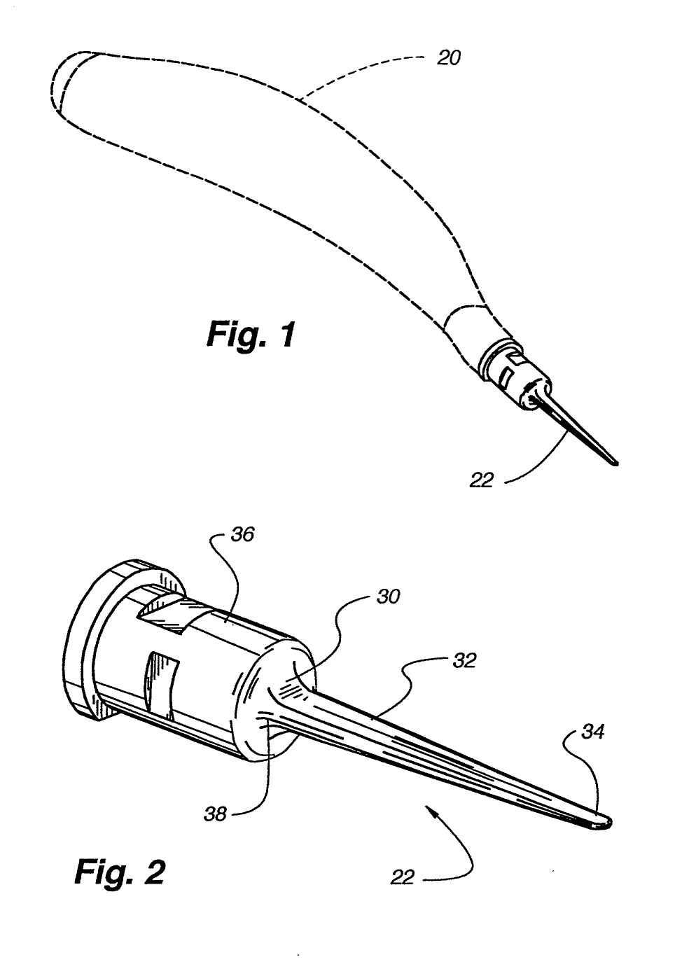

Referring to FIG. 1, a power dental flossing device 20 incorporating a flossing tip 22 of the present invention is disclosed. The flossing tip is generally elongated and has a generally rectangular cross-section of decreasing size along the length of the tip, terminating at an end which is inserted within the space between a pair of teeth. The tip 22 is resilient, flexible, compressible, and generally capable of withstanding forces imposed during the cleaning action. In one embodiment of the present invention, the tip 22 is made from materials such as Isoplast, Polybutylene Teriphthalate (PBT), acetal, ZYTEL™ (preferably type 101L) by DUPONT, nylon such as type 6/6, glass-filled material, or the like.

The tip 22 is adapted for use with a power dental flossing device 20, as shown in FIGS. 1 and 9, where the tip 22 is inserted by a user between adjacent teeth 24A, 24B for flossing. In one example of the present invention, the power dental flossing device 20 is a motorized device which is adapted to move the tip 22 in a linear direction, such as in a vertical direction upwardly and downwardly, during use as shown in FIG. 11. As will be described below, due to the unique shape of the tip 22 of the present invention, the tip provides multiple points of contact with the teeth being cleaned and maintains the proper orientation of the tip between teeth, which generally improves the effectiveness of the cleaning action of the power dental flossing device.

Referring now to FIGS. 2 and 4, in accordance with the present invention, the flossing tip 22 is an elongated member and includes a base portion 30, a central portion 32, and an end portion 34. The base portion 30 is attached to a connector portion 36 which is adapted to removably attach to an end of the power dental flossing device 20. In one example, the base portion 30 includes a fillet 38 having a generally triangular cross-section. The fillet 38 extends around the perimeter of the base portion and attaches the base portion 30 to the connector portion 36. The base portion 30 and the fillet 38 assist to distribute the stresses incurred along the tip 22 during use, and provide a solid foundation for supporting and connecting the tip 22 to the power dental flossing device 20 through the connector portion 36. In one example, the base portion 30 shown in FIGS. 2 and 4 has a length of approximately 0.026 inches from the connector portion to the top of the fillet 38.

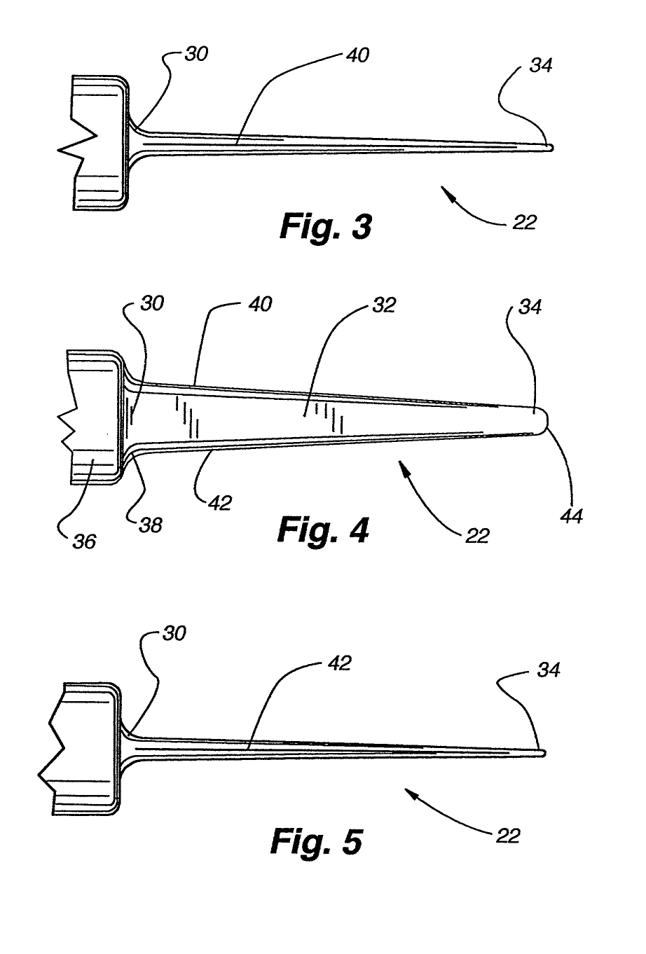

The central portion 32, which extends between the base portion 30 to the end portion 34 of the tip 22, has a top and bottom surface 40, 42 which define a width and height dimension. Referring to FIGS. 3 and 7, the width of the top surface 40 decreases along the length of the central portion 32 from the base to the end portion 34. In one example, the width is approximately 0.027 inches proximate the base portion 30, and the width is approximately 0.006 inches proximate the end portion 34. Preferably, the bottom surface 42 of the central portion 32 is substantially identical, in dimensions and shape, to the top surface 40; although the top and bottom surfaces may have different widths at any point along the tip thereby forming an angular cross-sectional profile, if desired. The length of the central portion 32 is approximately 0.51 inches in one example.

Alternatively, the tapering of the top and bottom surfaces 40, 42 can begin after a certain distance (for example, approximately 0.180 inches) along the length of the central portion 32, thereby increasing the mass of the tip proximate the base, which imparts greater strength to the entire tip.

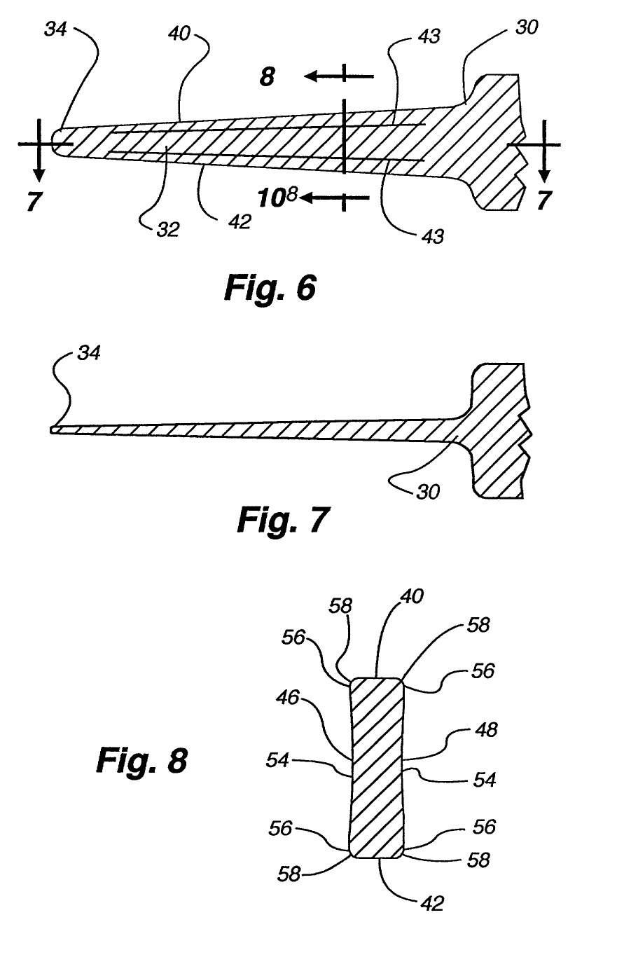

Referring to FIGS. 4 and 6, the top and bottom surfaces 40, 42 of the central portion 32 also define a height dimension that decreases along its length, being a maximum at the base 30 and a minimum at the end portion 34. Preferably, the central portion 32 has a height of approximately 0.077 inches proximate the base portion 30, and has a height of approximately 0.031 inches proximate the end portion 34.

Since the width of the top and bottom surfaces 40, 42 decreases along the length of the tip 22 from the base portion 30 to the end portion 34, and the height of the tip likewise decreases, these decreasing dimensions form a flossing tip which is easily slideably inserted between adjacent teeth, while also providing a flossing tip which maintains its orientation once inserted between the adjacent teeth. When the user has finished flossing between a pair of adjacent teeth, the tip is also easily removed from between the teeth due to these decreasing dimensions.

Further, in one example, the top and bottom surfaces 40, 42 of the central portion 32 can be embedded with thin strips 43 of reinforcing material such as metal, spring steel or the like, so as to increase the strength and durability of the tip while maintaining the resilient, flexible nature of the tip. One or more strips 43 are preferably encased in the material of the tip to protect the user's teeth and gums against contact with the strip. However, certain types of materials can be used for the strip 43 to avoid this effect.

Alternatively, a core made of stainless steel, or other reinforcing material, can be embedded within the central portion of the tip to increase the strength and durability of the tip while maintaining the resilient, flexible nature of the tip. The core has a shape generally similar to the central portion, but with smaller dimensions. In one example, the core is approximately 0.475 inches in length. Proximate the base end of the core, the core has a height of approximately 0.025 to 0.030 inches, and a thickness of approximately 0.010 inches. Proximate the end portion, the core has a height of approximately 0.008 to 0.010 inches, and a thickness of approximately 0.003 inches.

The central portion 32 transitions to the end portion 34 of the tip 22. Referring to FIGS. 4 and 5, the end portion 34 is generally flat along its sides and is rounded, which assists the user in guiding the tip properly within the interproximal space between adjacent teeth, and reduces poking of the gums. Referring to FIG. 4, the end portion 34 has a rounded or curved end 44, in one example, having a radius of curvature of approximately 0.02 inches. As mentioned above, the end portion has a width along its top and bottom surfaces of approximately 0.006 inches, and a height of approximately 0.031 inches, preferably. The end portion could have other shapes also, but the curved shape is desired for easily guiding the tip between teeth and for being comfortable, and reduces poking of the gums.

Referring to FIG. 11, as the tip 22 is slid between adjacent teeth, the end portion 34 of the tip 22 assists in dislodging food particles therein, and the sides 46, 48 of the tip 22 press against the sides 50, 52 of the adjacent teeth 24A, 24B which aligns the tip between the teeth as the tip is slid between the teeth. The distance which the tip 22 needs to be inserted between the teeth for alignment to occur will depend on the particular distance between the teeth 24A, 24B and the space between the teeth and gums of a user. Since the gap between teeth is generally a vertical slot, once a sufficient amount of the central portion 32 of the tip 22 has been inserted between the teeth, the tip is aligned therein. Since the tip 22 is made of resilient flexible material, the tip 22 of the present invention generally maintains its alignment between the teeth, as can be seen in FIGS. 9 and 11, even if the handle of the power dental flossing device 20 is slightly moved or slightly rotated (which may mis-align a conventional tip thereby generally decreasing the effectiveness of cleaning).

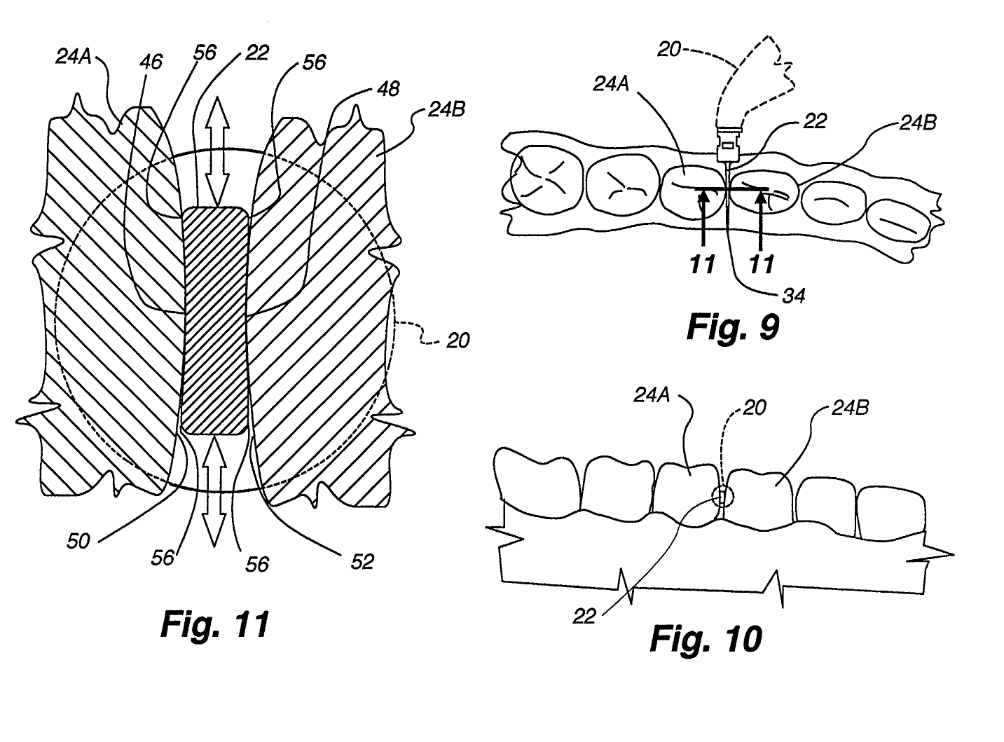

As shown in FIGS. 8 and 11, the cross-sectional geometry of the tip 22, at a section taken about the central portion 32, generally forms a rectangle in one example, defined by the top and bottom surfaces 40, 42 and the sides 46, 48 of the central portion 32. Preferably, the sides 46, 48 of the central portion 32 are longer than the width of the top and bottom surfaces 40, 42, which permits at least one side of the tip 22 to engage at least one side of a tooth during use. Preferably, the sides 46, 48 of the tip are curved inwardly towards one another, with a radius of curvature being approximately 0.20 inches in one example. The curve can have a variety of shapes, such as a simple curve or a complex curve, preferably a simple curve.

Referring to FIG. 8, a neck 54 is formed at the point where the tip has its narrowest thickness along the curved sides 46, 48. In one example, the neck 54 is formed along the curved sides 46, 48 at a midpoint between the top and bottom surfaces 40, 42 of the tip 22. Preferably, the neck 54 has a thickness of approximately 0.02335 inches at a point proximate the base portion 30; and a thickness of approximately 0.00587 inches proximate the end portion 34 of the tip. The varying thickness of the neck 54 along the length of the tip assists a user in guiding the tip between adjacent teeth, while providing a tip which is usable for flossing between teeth having various inter-proximal distances therebetween. The substantially rectangular cross-section also helps impart strength to the entire tip.

The curved sides 46, 48 help to improve the cleaning efficiency by improving the contact area between the sides 46, 48 of the tip 22 and the sides of the teeth. As can be seen in FIGS. 8 and 11, each curved side 46, 48 provides at least two points of contact 56 with a side of each tooth being flossed variously during the flossing process. During flossing, in one example, the tip compresses inwardly from the sides as the tip is moved between teeth, so that the tip can move into and through spaces narrower than the distance between the contact point on the top or bottom edge, respectively. The cross-sectional geometry of the tip shown in FIG. 8 and 11 is preferably generally rectangular with inwardly curved sides, because such a structure is easily manufactured and provides a strong cross-sectional structure which is also resiliently compressible. Other shapes, such as I-beam shaped, dog-bone shaped, or oval-shaped, are also feasible for providing indented or inset side walls.

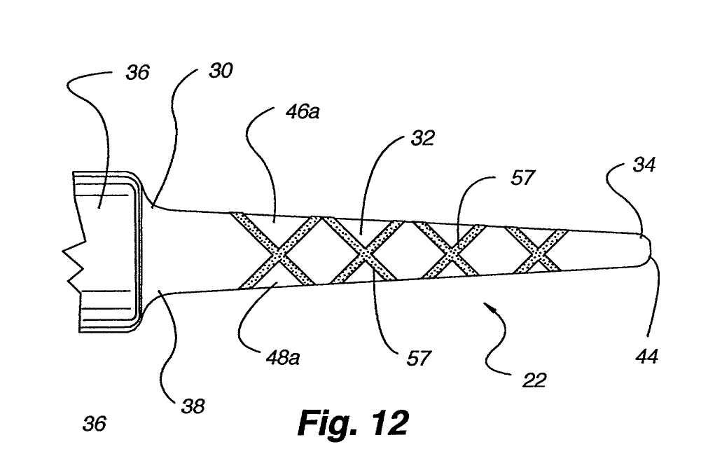

In an alternative embodiment as shown in FIG. 12, sides 46a, 48a have a surface treatment 57, such as a cross-hatching pattern, thereon. The surface treatment 57 generally helps improve the cleaning effectiveness of the tip by providing a plurality of gripping edges along the length of the tip to help break down plaque. In one example, the surface treatment 57 is formed on the sides of the tip by etching or cutting thin grooves or ridges or indentations in the sides 46a, 48a. Alternatively, a set of ribs or protrusions can be formed along the sides 46a,48a, in a cross-hatch or other pattern, to form the surface treatment 57. The protrusions can be made, for example, by etching thin grooves of ridges in the mold cavity of the tip. While a cross-hatch surface treatment 57 is shown, other surface treatments using different patterns or different densities of the pattern, may be used to improve the cleaning effectiveness of the tip.

The edges 58 of the tip, as shown in FIGS. 8 and 11, are preferably rounded which help prevent damage or injury to the gums of a user upon incidental contact with the tip 22 during use.

During use and referring to FIGS. 9, 10, and 11, the flossing tip 22 of the present invention, being coupled to a power dental flossing device 20, is inserted by the user between adjacent teeth 24A, 24B and the gum line. The end portion 34 of the tip 22 can dislodge any food particles embedded between the adjacent teeth. As the tip 22 is inserted deeper between the adjacent teeth, the curved sides 46, 48 of the central portion 32 of the tip engage the sides 50, 52 of the teeth. As the power dental flossing device 20 is activated and the tip 22 moves linearly, preferably vertically upwardly and downwardly, the contact points 56 of the tip, along with portions of the curved sides 46, 48 of the tip, rub against the sides 50, 52 of the teeth 24A, 24B to break up plaque and provide a dental cleaning action. The contact points move up and down in the space between the teeth to clean the sidewalls of the teeth. Since the tip is resiliently compressible, the contact points at the top and bottom edges of the tip can compress and extend to fit the differing dimensions of the gap to maintain contact. The user can move the tip to contact and clean different portions of the sides of the teeth, and the tip will generally maintain the proper orientation with respect to the teeth to continue to provide an effective dental cleaning action.

While the invention has been particularly shown and described with reference to a preferred embodiment thereof, it will be understood by those skilled in the art that various other changes in the form and details may be made without departing from the spirit and scope of the invention.

1. A tip for a power dental flossing device, comprising:
a base portion for supporting the tip when coupled to the dental flossing device;
a central portion having a substantially rectangular cross-section, and having a first end and a second end, said first end coupled to said base portion; and
an end portion coupled to said second end of said central portion, for insertion between a pair of adjacent teeth of a user.

2. The tip of claim 1, wherein the central portion has a top surface, a bottom surface, and a pair of sides, wherein the top and bottom surfaces having a substantially equal width, and the sides have a substantially equal height, and wherein the height of the sides are larger than the width of the top and bottom surfaces.

3. The tip of claim 1, wherein the central portion has a top surface, a bottom surface, and a pair of sides, wherein at least one of the sides is curved.

4. The tip of claim 3, wherein the at least one of the sides is curved inwardly.

5. The tip of claim 3, wherein the at least one of the sides is indented.

6. The tip of claim 1, wherein the central portion has a top surface having a first width proximate the base portion, and having second width proximate the end portion, the first width being larger than the second width.

7. The tip of claim 1, wherein the central portion has at least one side having a first height proximate the base portion, and having second height proximate the end portion, the first height being larger than the second height.

8. The tip of claim 1, wherein at least one strip of reinforcing material is embedded within the central portion.

9. The tip of claim 1, wherein the central portion has a plurality of edges, said edges being rounded to reduce impact on the user's gums during use.

10. The tip of claim 1, wherein the end portion has a curved end.

11. The tip of claim 1, wherein the central portion has at least one side having a cross-hatched surface treatment thereon.

12. The tip of claim 1, further comprising a core formed from a reinforcing material, wherein said core is embedded within the central portion.

13. A method of flossing teeth with a dental flossing device, comprising:
providing a tip with a substantially rectangular cross-section adapted to be inserted between a pair of teeth of a user, the tip adapted to be attached to the dental flossing device;
providing for the user to insert the tip between the pair of teeth; and
providing for the user to activate the power dental flossing device, thereby moving the tip at least vertically upwardly and downwardly along at least a portion of one side of one of the pair of teeth for cleaning.

14. The method of claim 13, further comprising providing at least one strip of reinforcing material embedded within the central portion.

15. The method of claim 14, wherein as the tip is moved at least vertically upwardly and downwardly along at least a portion of one side of one of the pair of teeth for cleaning, the tip compresses between the pair of teeth.
